(19) United States
(12) Patent Application Publication
(10) Pub. No.: US 2005/0255808 A1
(43) Pub. Date: Nov. 17, 2005

(54) Method and apparatus to provide power control with finite rate feedback for cooperative relay networks

(75) Inventors: Nasir Ahmed, Houston, TX (US); Mohammad Ali Khojastepour, Plainsboro, NJ (US); Ashutosh Sabharwal, Houston, TX (US); Behnaam Aazhang, Houston, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/094,093

(22) Filed: Mar. 29, 2005

Related U.S. Application Data
(60) Provisional application No. 60/557,579, filed on Mar. 29, 2004.

(51) Int. Cl. H04B 7/14

(52) U.S. Cl. 455/24

(57) ABSTRACT

A method for reducing outages in a cooperative network comprising measuring a channel gain for each of a plurality of received signals one of the received signals comprising a source signal, executing an algorithm utilizing the channel gain of the source signal and at least one other of the plurality of channel gains to determine a source transmit power value, and transmitting the source transmit power value to the source.

### CLAIM OF PRIORITY FROM COPENDING PROVISIONAL PATENT APPLICATION

This patent application claims priority under 35 U.S.C. §119(e) from Provisional Patent Application No.: 60,557,579, filed Mar. 29, 2004, the disclosure of which is incorporated by reference herein in its entirety.

### FIELD OF THE INVENTION

This invention relates generally to wireless communications systems and methods and, more specifically, relates to power control techniques for use in cooperative networks.

### BACKGROUND OF THE INVENTION

In a distributed network of nodes, node cooperation can be exploited to achieve diversity. This type of cooperation diversity was first studied for the case of two transmission nodes and one destination in A. Sendonaris, Advanced Techniques for Next-Generation Wireless System, PhD thesis, Rice University, May, 1999, and was shown to provide gains in achievable rate over multiple access transmission.

A non-feedback method for use in a distributed network was proposed in N. Laneman, D. Tse and G. Wornell “Cooperative Diversity in Wireless Networks: Efficient Protocols and Outage Behavior,” Accepted for publication to IEEE Trans. on Info. Theory April 2003.

Reference may also be made to WO 01/65637 A2, “Cooperative Mobile Antenna System”, Yuri Owechko (HRL Laboratories, LLC); WO 02/15613 A1, “Method and Apparatus for Cooperative Diversity”, Paul Gorday et al. (Motorola, Inc.); and to WO 03/003672 A2, “Improvements in or Relating to Electronic Data Communication Systems”, Mischa Dohler et al. (King's College London).

To overcome the effects of channel fading, some form of diversity can be employed. Most mobile equipment, such as mobile telephones, currently in use employs a single antenna and so cannot readily employ MIMO diversity. However, through cooperation among users in sending their data to the destination, a virtual antenna array may be created and this can be used to obtain diversity. To realize further gains from cooperation, power control at the transmitter may be employed.

The problem of power control in a network setting has not been adequately addressed previously. In a channel with just one source and destination, power control algorithms based on finite rate feedback have been proposed. In these algorithms, the destination is generally assumed to have a perfect estimate of the channel. Upon receiving or deriving this estimate, the destination computes a power control level for the transmitter such that a long-term average power constraint is met. The index to this power control level is fed back to the transmitter through the feedback link. The transmitter then selects the appropriate power level from the index it receives.

When the feedback link to the transmitter is of finite capacity, the prior art does not appear to address how best to perform power control in a network. What is therefore needed is a procedure to address this issue for the network setting, as well as a power control algorithm that enables gains in diversity and reduces outage probability as compared to current power transmission methods.

### SUMMARY OF THE INVENTION

In accordance with one aspect of the present invention, a method for reducing outages in a cooperative network is provided that includes measuring a channel gain for each of a plurality of received signals one of the received signals comprising a source signal, executing an algorithm utilizing the channel gain of the source signal and at least one other of the plurality of channel gains to determine a source transmit power value, and transmitting the source transmit power value to the source.

In accordance with another aspect of the present invention, a cooperative network comprises a source for transmitting a source signal having a source transmit power the source capable of adjusting the source transmit power in response to a source transmit power value, at least one relay for transmitting a relay signal, and a destination for receiving the source signal and the at least one relay signal, executing a power control algorithm using a plurality of channel gains derived from the source signal and the at least one relay signal to produce the source transmit power value.

### BRIEF DESCRIPTION OF THE DRAWINGS

FIG. 1 shows a network model, in particular the layout of a relay channel;

FIG. 2 illustrates the structure of power control regions when β=1 and γ and δ are random;

FIG. 3 illustrates simulation results comparing direct transmission power control and various network power control strategies; and

FIG. 4 illustrates outage probability results for the relay node being at a closer distance to the destination, and also for random β, where in all curves, σ_{s,d}=1 and both γ and δ undergo Rayleigh fading.

FIG. 5A is a perspective view, and FIG. 5B is a block diagram schematic, of a transceiver configured according to an embodiment of the present invention.

### DETAILED DESCRIPTION OF THE INVENTION

Embodiments of this invention use algorithms for power control in a network setting. More specifically, given a finite rate feedback link, the algorithm reduces the outage probability of transmission from a source to a destination through a network. The algorithm employs channel state information, preferably of the entire network in the power control process. With one bit of feedback, embodiments of the invention enable a doubling of the slope of the outage probability versus signal to noise ratio curve over constant power transmission. Simulations confirm the diversity gains of performing power control over constant power transmission.

Disclosed herein is a method, system and computer program to minimize outages in a cooperative network comprised of at least one source, at least one relay and at least one destination, comprising executing a power control algorithm that considers the channel states of all network links, in combination with at least one bit of feedback that is sent back to the source from the destination.

In an embodiment described in more detail below, power control strategies with finite rate feedback are described for a cooperative channel. It is shown that quantized feedback information can lead to a significant reduction in outage probability for a cooperative relay network. To obtain an increase in diversity order and significant reductions in outage probability over constant power cooperative signaling, algorithms are disclosed that exploit the channel states of all network links. Furthermore, with the use of at least one feedback bit the power control algorithm is shown to at least double the diversity order of constant power transmission. To quantify the performance increase of using power control in the cooperative network, there is derived a lower bound on the diversity order. It is shown that future network protocols utilizing feedback in accordance with this invention can beneficially exploit the potential gains of network coding.

It is further shown that transmitter power control in cooperative communication networks can lead to significant improvements in outage performance if the entire network state is used to determine the instantaneous transmitter power. For the case of amplify and forward (AF) protocols in ‘cheap’ relay networks, see in this regard M. A. Khojastepour, A. Sabharwal and B. Aazhang, “On the Capacity of ‘Cheap’ Relay Networks,” In Proc. 37th Annual Conf. on Info. Sciences and Systems, March 12-14, Baltimore, Md., 2003, it is shown that only one bit of feedback information suffices to double the diversity order of the system compared to the non-feedback method proposed in the above-captioned J. N. Laneman, D. N. C. Tse and G. W. Wornell “Cooperative Diversity in Wireless Networks: Efficient Protocols and Outage Behavior,” IEEE Trans. Inform. Theory, vol. 50, no. 12, pp. 3062-3080, December 2004.

The power control policy in accordance with this invention is simple to compute as the power control levels can be obtained in a recursive manner, whereas the optimal power control policy requires the solution to a complex optimization problem with a nonlinear constraint. It is further shown the there exists a possibility that using all the channel states may be essential to extract the large gains, by considering power control policies which use only direct link information.

To assess the gains in using the network power control algorithm, two previous solutions can be used for comparison purposes. The first involves transmitting over the network with constant power, and observing the improvement in outage probability by employing power control with finite rate feedback. In this case, the invention offers substantial gains. If one considers the special network scenario of a relay channel, then a second order diversity is obtained by using constant power transmission. However, with just one bit of feedback and network power control, the diversity order is doubled. The second point of comparison is with a single link channel with the same amount of feedback information. In this case, network power control with one bit of feedback still has double the diversity and improved outage probability performance over power control in a single link system with one bit of feedback. This validates the need for using user cooperation and for network power control. One significant advantage of this invention is the large reduction in outage probability that is obtained with just one bit of feedback.

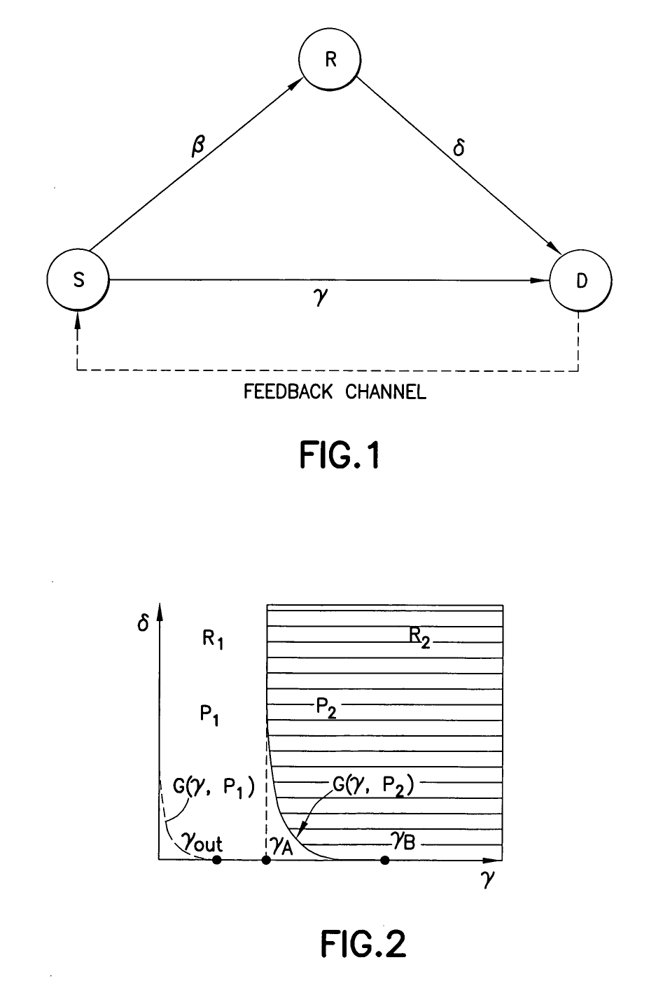

An exemplary network model is shown in FIG. 1. Node R acts as a relay for node S, in order to send data to destination D. The transmission is assumed to occur in a time division manner. In the first half of a time slot, the source transmits to both the relay and destination. In the second half of the time slot, the relay transmits the same information to the destination, while the source remains idle. At the relay and destination, the received signal is corrupted by additive white Gaussian noise with unit variance.

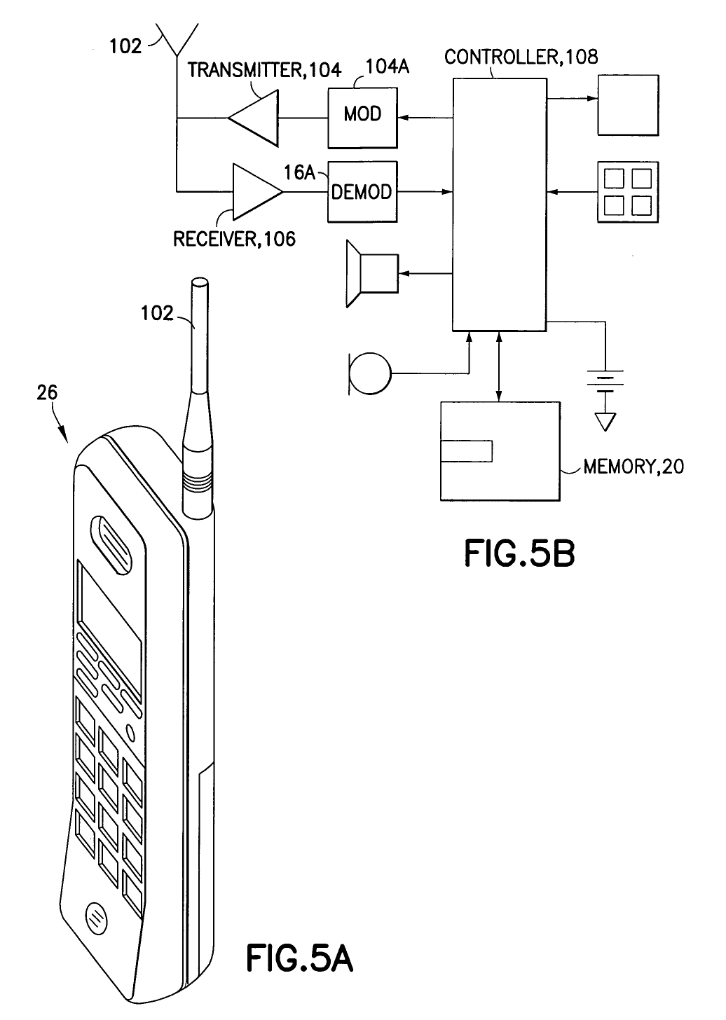

With reference to FIGS. 5a and 5b, there is illustrated an exemplary transceiver device which may serve as a relay, a source, or a destination. It is possible that the relay may be formed of a physical artifact capable of deflecting a source or other signal. In addition, the relay can be a node or terminal operating in a fashion similar to that of the source. In instances of time in which cooperation is taking place, the relay functions to receive the source signal from the source and to transmit some function of the source signal. The function may be, but need not be, an amplification as described more fully below. The transceiver 26 may be, but is not limited to, a cellular telephone or a personal communicator. The transceiver 26 includes one or more antennas 102 for transmitting signals to and for receiving signals. The transceiver 26 includes a modulator (MOD) 104A, a transmitter 104, a receiver 106, a demodulator (DEMOD) 106A, and a controller 108 that provides signals to and receives signals from the transmitter 104 and receiver 106, respectively. It is understood that the controller 108 also includes the circuitry required for implementing the algorithms of the present invention. By example, the controller 108 may be comprised of a digital signal processor device, a microprocessor device, and various analog to digital converters, digital to analog converters, and other support circuits. The control and signal processing functions of the transceiver 26 are allocated between these devices according to their respective capabilities.

Controller 108 may additionally operate to perform a decoding operation as described more fully below. In such an instance, a table may be stored in memory 120 for retrieval by controller 108.

The fading values for the links in the relay channel are denoted as a_{i,j}, where i∈(S,R) and j∈(R,D). It is assumed that the gains, a_{i,j}, for each channel (channel gains) are independent, circularly symmetric Gaussian random variables with zero mean. The variance of the fading distributions are σ_{i,j}², where i∈(S,R) and j∈(R,D). For the remainder of this description, we will denote γ=|a_{S,D}|², β=|a_{S,R}|² and δ=|a_{R,D}|².

In N. Laneman, D. Tse and G. Wornell “Cooperative Diversity in Wireless Networks: Efficient Protocols and Outage Behavior,” Accepted for publication to IEEE Trans. on Info. Theory April 2003, an amplify and forward (AF) protocol was developed and shown to achieve full diversity. Its simplicity and the fact it achieves full diversity are the reasons that the inventors have chosen the AF protocol as the relaying method. The amplification at the relay node is performed such that the relay experiences no more than Pᵣₑₗ power on average. For this protocol, the performance limits are characterized by the following achievable rate expression

$${R}_{AF} ( γ , β , δ , P , {P}_{rel} ) = \frac{1}{2} log ( 1 + P γ + \frac{P β {P}_{rel} δ}{1 + P β + {P}_{rel} δ} ) . \qquad ( 1 )$$

In (1), P is the transmit power for the source, and Pᵣₑₗ is the relaying node's average power.

The power control procedure with finite rate feedback for the relay network is now described. Power control with perfect channel state information (CSI) for direct transmission was analyzed in G. Caire, G. Taricco and E. Biglieri “Optimum Power Control over Fading Channels,” IEEE Trans. on Info. Theory, vol. 45, no. 5, pp., 1468-1489, July 1999, and it was shown that with a long term power constraint, the probability of outage could be significantly reduced compared to constant power transmission. It is assumed herein that the receiver or destination (D) quantizes the power control information and transmits this quantized information through a noiseless feedback channel or link to both the source (S) and the relay (R) as shown in FIG. 1.

Consider now the case where the destination D can perfectly measure the relay network channel state (γ,β,δ). Given that the receiver uses Q bits for feedback, the power control algorithm selects a power-tuple P_{q}=(P_{q}, P_{rel,q}) from a power control codebook C of cardinality 2^{Q}, where q∈{1, . . . ,2^{Q}}. The power-tuple P_{q} denotes a pair of power levels P_{q}=(P_{q}, P_{rel,q}) such that the source power is P_{q} and the relay power is P_{rel,q}. The index of the selected power-tuple is transmitted to both the source and relay. The source and relay also have copies of C. Given that index q is sent on the feedback link, the source will then transmit with power P_{q} and the relay will use power P_{rel,q}.

The elements of C are chosen to maintain the power constraints of the source and relay. Consider a power control function P(γ,β,δ) which maps the network channel state to a codebook element. To maintain the long term power constraint of the source and relay, it is desirable to ensure that E[P(γ,β,δ)]=(P,Pᵣₑₗ) where E is the expectation operation. The objective of the power control algorithm is to find a P(γ, β,δ) that minimizes the outage probability while meeting the power constraint.

Described now is a power control algorithm that takes into account the entire network channel state in the outage minimization process. The power control algorithm is developed such that the source performs power control and the relay simply transmits with constant power. Along with the algorithm, an analysis is made of the outage probability, and it is shown how power control with even one bit of feedback can double the diversity order of constant power transmission. After the outage analysis, a case where the relay also transmits with a long term power constraint is analyzed.

First, consider a power control algorithm in which the relay is restricted to use a constant power in each time slot, but the source has the ability to vary its power to meet a long term average power constraint. In other words, power-tuple P_{q} from C has the form (P_{q},Pᵣₑₗ). The algorithm takes into account the entire network channel in an effort to minimize the outage probability.

It is important to note that while this description assumes the use of one bit of feedback in the power control algorithm, the practice of this invention is not limited to the use of only one feedback bit, and multiple feedback bits may be employed if so desired.

Consider a receiver that has a perfect estimate of the network channel states (γ,β,δ). For ease of explanation, assume that β=1, and later it will be discussed how to extend the algorithm to the case of random β. Given one bit of feedback, the transmitter can select one out of two possible power levels. Referring to FIG. 2, it can be seen that the space defined by all pairs (γ,δ) can be divided into two regions R₁ and R₂, corresponding to the power levels P₁ and P₂, respectively. To use the power control algorithm, the power levels are preferably determined along with the curve G(γ,P₂) defining the boundary between R₁ and R₂. Given power levels P₁ and P₂, the long term average power constraint of the source can be written as
P=∫_{R}_{₁}P₁f(γ,δ)dγdδ+∫_{R}_{₂}P₂f(γ,δ)dγdδ, (2)
where f(γ,δ) is the joint probability distribution of the channel attenuations for the cooperative channel.

One significant feature of the power control regions is that in region R₂, the assigned power P₂ is the minimum required to guarantee zero outage for any point in the region. This is a fundamental property of all finite rate feedback power control algorithms (see, for example, S. Bhashyam, A. Sabharwal and B. Aazhang, “Feedback Gain in Multiple Antenna Systems,” IEEE Trans. on Comm., vol. 50, no. 5, pp., 795-798, May 2002). With this in mind, given a transmission rate R and a constant relay power Pᵣₑₗ, power level P₂ is the solution to
R_{AF}(γ,1,δ,P₂,Pᵣₑₗ)=R. (3)

From FIG. 2 it can be seen that the boundary between R₁ and R₂ is separated by a curve G(γ,P₂). This curve is found by solving for δ in (1), and has the following form

$$δ = G ( γ , {P}_{2} ) = \frac{( 1 + {P}_{2} ) ( K - γ {P}_{2} )}{{P}_{rel} ( {P}_{2} - K ) + {P}_{rel} {P}_{2} γ} , \qquad ( 4 )$$

where K=e^{2R}−1. Any (γ,δ) along this curve requires exactly power P₂ for zero outage, while any other points in R₂ require less than P₂ for zero outage. In this way, the entire region R₂ is in zero outage. Therefore, calculating the outage probability for this power control method implies an analysis of region R₁.

As was discussed in S. Bhashyam, A. Sabharwal and B. Aazhang, “Feedback Gain in Multiple Antenna Systems,” IEEE Trans. on Comm., vol. 50, no. 5, pp., 795-798, May 2002, two possibilities exist for P₁. If P₁<P₂, then it suffices to set P₁=0 and save power, because doing so will not change the outage probability since channel states closer to the origin require more power to invert the effects of the channel. Therefore, the two cases of interest are when P₁=0, and P₁>P₂. The outage probability is calculated for both cases, and the minimum is taken for the particular power constraint.

First, consider policies where P₁=0. The outage probability is simply the likelihood of being in R₁, and can be expressed as
Πₒᵤₜ^{a}=∫_{R}_{₁}f(γ,δ)dγdδ. (5)
For P₁=0, the boundary of region R₁ is determined by the curve G(γ,P₂). The power level P₂ is found as the solution to
P=P₂∫_{R}_{₂}f(γ,δ)dγdδ. (6)

Next, consider the case where P₁>P₂. In general the optimal solution in this scenario is difficult to calculate, and instead it is preferred to resort to a more tractable solution. It is preferred to allocate equal power to the subregions R₁ and R₂. This technique was shown to be close to optimal for the single link channel, even with one feedback bit (see A. Khoshnevis and A. Sabharwal, Performance of Quantized Power Control in Multiple Antenna Systems, Accepted for publication to ICC 2004).

Referring to FIG. 2, in R₁ power P₁ is sufficient to guarantee zero outage for all (γ,δ) to the right of G(γ,P₁). It can be easily verified that G(γ,P₁) intersects the γ axis at γₒᵤₜ=K/P₁ and G(γ,P₂) has a γ-intercept at γ_{B}=K/P₂. As a result of the simplifying assumption regarding the total power in each region, the power levels P₁ and P₂ can be solved in a recursive manner, as follows. First, power level P₂ is solved as the solution of

$${P}_{2} {Δ}_{2} = \frac{P}{2} ,$$

where Δ₂ is the probability of the network channel state being in region R₂, i.e.,

$${Δ}_{2} = {\int }_{{γ}_{B}}^{∞} {\int }_{0}^{∞} f ( γ , δ ) ⅆ δ ⅆ γ + {\int }_{{γ}_{A}}^{{γ}_{B}} {\int }_{G ( γ , {P}_{2} )}^{∞} f ( γ , δ ) ⅆ δ ⅆ γ , \qquad ( 7 )$$

where γ_{A}=K/P₂−1. Once P₂ is known, P₁ can be easily solved since it is known that P₁(1−Δ₂)=P/2.

This recursive procedure is useful in that it can be easily extended to multiple feedback bits, which is not the case for the optimal power control scheme. To calculate the outage probability of this scheme, one may simply find the probability that the network channel state (γ,δ) lies below the curve G(γ,P₁). In order to do this, if one considers P* as the minimal power required for zero outage, then P* can be found as the solution to
R_{AF}(γ,1,δ,P*,P_{ewl})=R. (8)

With this solution in hand, the outage probability using equal power subregions can be expressed as
Πₒᵤₜ^{b}=∫_{(γ,δ):P*≧P}_{₁}f_{γ,δ}(γ,δ)dγdδ. (9)

The overall outage probability is the minimum of the outage probabilities obtained using the two possible scenarios. In other words, Πₒᵤₜ=min{Πₒᵤₜ^{a},Πₒᵤₜ^{b}}.

When β is also a random quantity, the regions R₁ and R₂ are volumes in the space defined by all positive (γ,β, δ). For a given β, the plane defined by all positive (γ,δ) is identical to FIG. 2, except now γ_{A}=γ_{B}−β. By considering different values of β, the 3-dimensional volumes for R₁ and R₂ can be visualized. The recursive power control algorithm operates in a similar manner. First, power level P₂ is found by integrating over region R₂ and assuming that the total power in this region is P/2. Once P₂ is found, P₁ is determined through direct substitution. Results will be presented below for cases where β is a constant and also where it can be a random quantity.

The performance of the presently preferred power control algorithm is now investigated by developing a bound on the outage probability for one bit of feedback. One bit of power control on the single link channel can be shown to double the diversity over constant power transmission. In this section, a similar trend is shown for the network setting. More specifically, bounds are obtained on the diversity order by using a network power control strategy with the amplify and forward transmission protocol. The main result can be summarized in the following theorem.

Theorem 1. For the amplify and forward protocol, as Pᵣₑₗ=P increases, the optimal one bit network power controls offers at least a fourth order diversity gain. The outage probability can be upper bounded by

$${\prod }_{out} \frac{2 {K}^{4}}{{σ}_{r , d}^{2} {P}^{3} g ( P , K , {σ}_{r , d} ) - 4 {σ}_{r , d}^{2} {P}^{3} K} , where \\ g ( P , K , {σ}_{r , d} ) = 2 K + P + \sqrt{4 {K}^{2} + P ( P - 4 K ) + 2 {K}^{2} / {σ}_{r , d}} \qquad ( 10 )$$

and K=e^{2R}−1.

It can be seen that the effect of σ_{r,d}² should provide a shift in the outage curve. Recalling that constant power cooperative transmission provides a diversity order of two when the amplify and forward protocol is used, using one bit for power control has doubled the slope of the outage versus power curve to four.

In the power control algorithm discussed previously, the relay node has transmitted with constant power Pᵣₑₗ in each time slot. Constant power transmission is always inferior to power control in fading channels. Consider a simple example, where the power control algorithm uses on-off signaling. When the receiver tells the source to transmit nothing, it makes no sense for the relay to simply amplify the noise, and in fact the relay could save power by not transmitting. In portions of time where the source transmits at maximum power, the relay could also send at a power higher than its average and help reduce the outage probability further. Using the above logic, it is apparent that controlling the power at the relay can provide further reductions in outage probability.

An example of such a scheme is described next. The destination (D), upon obtaining the network channel state, determines a global power level which both the relay and the source are to transmit at concurrently. Based on the notation used above, this corresponds to power control policies where element q from C has the form P_{q}=(P_{q},P_{q}). The achievable rate for such a transmission scheme is simply R_{AF}(γ,β,δ,P,P). The curve defining the boundary between R₁ and R₂ can be found by solving for δ in R_{AF}(γ,β, δ, P₂,P₂)=R. This is a similar to Equation 3, except now Pᵣₑₗ is replaced by P₂. Aside from this new curve, the algorithm operates identically to that described above. It is shown below how performing such a technique offers gains over simply setting Pᵣₑₗ to a constant value over all network states.

The power control strategies described above rely on the entire network state (γ,β, δ). A discussion will now be provided of the importance of using the entire network state in the power control process. More specifically, a power control algorithm is presented which relies solely on the source-destination fading state γ in the power control process, and the outage probability obtained is compared to the network power control strategies derived earlier. In order to do this, the following two lemmas are employed to analyze the outage probability.

Lemma 1. Consider the amplify and forward protocol transmitting at a rate R and average power P. For a fixed β and δ, assuming that P₁≦P₂, the outage probability for 1-bit power control can be written as

$${\prod }_{out}^{a} ( {γ}_{0} , {α}_{2} \vert δ , β ) = 1 - {ⅇ}^{- {γ}_{0}} + {ⅇ}^{- {γ}_{0}} ( 1 - {ⅇ}^{- {z}_{out} ( {α}_{2} , β , δ )} ) I ( {z}_{out} ( {α}_{2} , δ , β ) > {γ}_{0} ) ,$$

where α₂=P₁/P, I(·) is the indicator function and zₒᵤₜ is given by

$${z}_{out} = ( x , δ , β ) = \frac{{ⅇ}^{2 R} - 1}{Px} - \frac{δ {P}_{rel} β}{1 + {P}_{rel} δ + P β x} ,$$

and Pᵣₑₗ is the average relay transmit power.

Lemma 2. Consider the amplify and forward protocol transmitting at a rate R and average power P. For a fixed β and δ, and assuming that P₁>P₂, the outage probability for 1-bit power control can be written as
Πₒᵤₜ ^{b}(γ₀,α₁,α₂|δ,β)=(1−e^{-γ}^{₀})(I(z₁>γ₀)+I(z₁<γ₀)(1−e^{-z}^{₁}))+e^{-γ}^{₀}I(z₂>γ₀)(e^{-γ}^{₀}−e^{-z}^{₂}),
where, α₁=P₁/P, α₂P₂/P, z₁=zₒᵤₜ(α₁,δ,β) and z₂=zₒᵤₜ(α₂,δ,β). With these lemmas in hand, the outage probability for a network power control algorithm using reduced channel state information can be derived. The result can be summarized in the following theorem.

Theorem 2. For the amplify and forward protocol transmitting at a rate R, and average power P, 1-bit power control based only on the direct link fading state γ leads to an outage probability of
Πₒᵤₜ=min {∫_{β}∫_{δ}Πₒᵤₜ^{a}(γ₀^{a},α₂^{a}|δ,β)f_{β,δ}(β,δ)dβdδ∫_{β}∫_{δ}Π(γ₀^{b},α₁^{b},α₂^{b}|δ,β)f_{β,δ}(β,δ)dβdδ}, (11)
where f(β,δ) is the joint probability distribution for β and δ, α₂^{a}=e^{γ}^{₀}^{^{a}}, and γ₀^{a} is the solution to

$${γ}_{0}^{a} {ⅇ}^{{γ}_{0}^{a}} = \frac{{ⅇ}^{R} - 1}{P} .$$

Additionally,

$${γ}_{0}^{b} = \frac{{ⅇ}^{R} - 1}{P {α}_{2}^{b}}$$

and α₂^{b} and α₁^{b} can be solved through the following set of equations

$$( {α}_{2}^{b} - 1 ) \frac{{ⅇ}^{R} - 1}{{( {α}_{2}^{b} )}^{2}} + 1 - {ⅇ}^{- \frac{{ⅇ}^{R} - 1}{P {α}_{2}^{b}}} = 0 , \\ {α}_{1}^{b} = \frac{1 - {α}_{2}^{b}}{1 - {ⅇ}^{- \frac{{ⅇ}^{R} - 1}{P {α}_{2}^{b}}}} + {α}_{2}^{b} . \qquad ( 12 )$$

Here it is assumed that the destination only uses the direct link channel state γ in its power control algorithm. In some situations where γ is large, poor channels on the relay links may corrupt the transmission, yet the algorithm ignores this point. In the results detailed below, it will be seen that simply relying on δ results in poor performance compared to the scenario where the entire network state is accounted for.

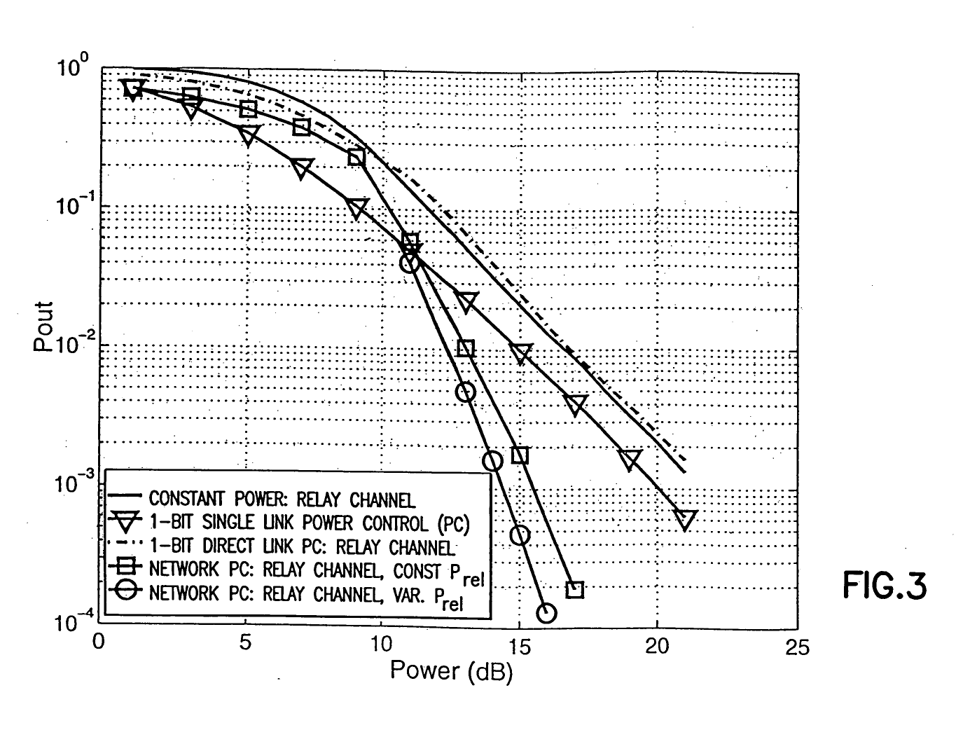

Shown now are numerical results that illustrate the performance of the above-described power control algorithms for the cooperative channel. Observing FIG. 3, the second order diversity for constant power transmission using the amplify and forward protocol can be seen, as was discussed in N. Laneman, D. Tse and G. Wornell “Cooperative Diversity in Wireless Networks: Efficient Protocols and Outage Behavior,” Accepted for publication to IEEE Trans. on Info. Theory April 2003.

Next, the outage probability curve for the network power control strategy is shown using the technique described above for the case where β=1. In this strategy, the total power in each subregion is equal. It can be seen that the outage performance with this method is far superior to constant power allocation. In fact, with one bit of feedback, the slope of the outage curve for the network power control the slope is four, as predicted by the lower bound analysis. However, for constant power transmission, the slope is only two. In this power allocation scheme, the relay simply transmits with a constant power in each time slot. The results for variable source and relay powers is also shown in FIG. 3. This joint method of power control can be seen to provide gains on the order of 1 dB at high powers over constant relay power allocation. In this technique, the destination transmits a single bit of feedback corresponding to a global power control level to both the source and relay. From the results of FIG. 3, it is evident that power control using the entire state of the network provides significant gains over constant power allocation.

Additionally, in this same FIG. 3 is shown the outage probability results discussed above, where the receiver uses only the direct link channel state γ in deciding a power control level. Surprisingly, it is seen that ignoring the relay links is asymptotically worse than constant power transmission. The reason for this is that for some portions of time, the direct link scheme allocates high power when the measured γ is small, but in these cases high values for the relay channel states β and δ may occur, and less power should actually be used in order to transmit with higher power at a later time and maintain the same average power. As a result, in this network setting, it is better to do no power control at all then to use only the direct link channel state. As a final point of comparison, there are plotted the optimal one bit power control results for a network with no relay, from the results of S. Bhashyam, A. Sabharwal and B. Aazhang, “Feedback Gain in Multiple Antenna Systems,” IEEE Trans. on Comm., vol. 50, no. 5, pp., 795-798, May 2002. It can be seen that this curve has a slope of two, whereas the network power control schemes were shown to have double this slope. This justifies the utility of using power control in conjunction with a network code.

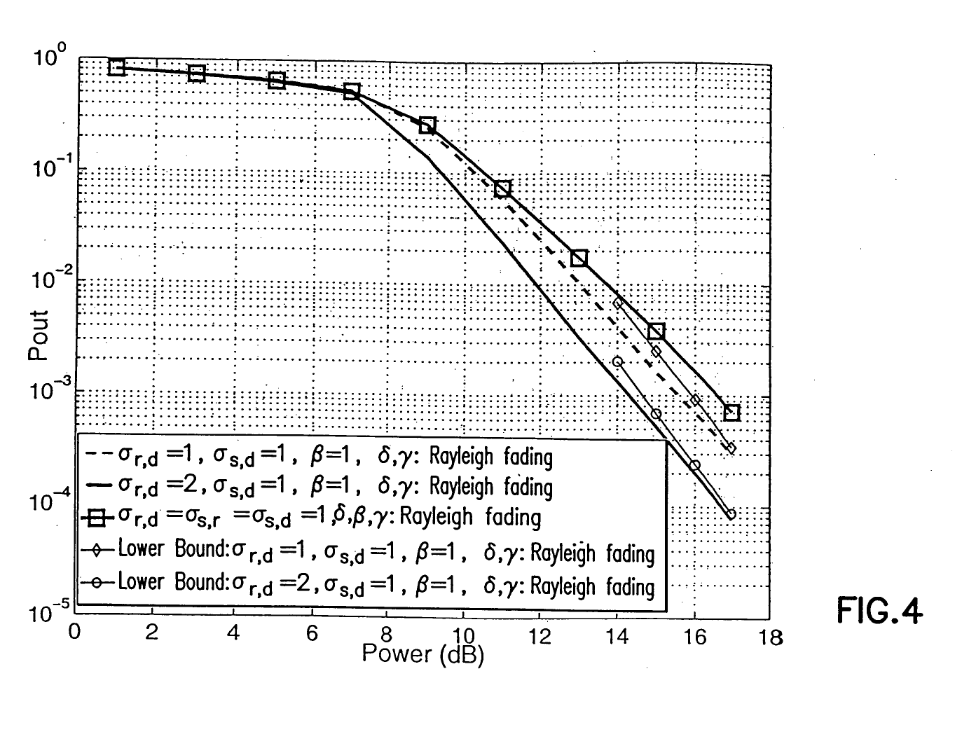

In FIG. 4, results are shown for σ_{r,d}=1 and σ_{r,d}=2, where the latter case corresponds to the scenario where the relay is located at a closer distance to the destination than the source. It can be seen that the closer distance does not increase the diversity order, but it provides a shift in the outage curves and better performance. This is expected as the benefits of cooperation are especially evident for relays experiencing good channel conditions.

Up to this point, all the results have assumed β=1 and is deterministic. The scenario when β is random was also discussed above, with the control regions now being volumes in a space corresponding to the 3-tuple (γ,β,δ). Power control under such a scenario is also shown in FIG. 4. It can be seen that under this channel model, the diversity order is the same, however there is a shift to the right of the outage probability curve. This is expected because the extra fading does not give an independent look at the same data, but further corrupts the data sent on the relay link. Fading in such scenarios is never beneficial. On this same figure, the bounds to the outage probability are shown and it can be seen that the bounds closely follow the simulated results and confirm the fourth order diversity behavior for one bit of network power control. The optimal network power control for one bit of feedback, which is currently being investigated, can only do better than this bound.

The problem of outage minimization through network power control has been addressed above and presently preferred embodiments of power control algorithms have been described. It has been observed that using the entire state of the network to perform power control is preferred to obtain sizable reductions in outage probability and, specifically, to provide diversity gains over constant power transmission. Additionally, there has been presented a lower bound to demonstrate the increased diversity order obtained by using the preferred network power control algorithm.

The presently preferred power control algorithms may be executed by a suitably programmed digital data processor that is co-located with the network node that is controlling the power, or it may be located remotely from and the results of the execution of the power control algorithm may be communicated to the power controlling node through a data communications network.

All of the processing in the algorithm may be performed at a base station, and only an index need be fed back to the source. This index may be utilized by the source to perform a table look up or similar decoding operation to deduce a source transmit power corresponding to the feedback signal. The feedback signal is preferably a binary code. In the instance when the feedback signal sent from the destination to the source is comprised of a single bit, the bit may form an index from which may be deduced one of two power levels P₁, P₂ as discussed above.

The number of possible power levels encoded in the feedback signal is bounded by the maximum number of regions R_{N} where N is the total number of relays plus one (corresponding to the source). Therefore, in the more general case that N is greater than two, as is illustrated in FIG. 1, the feedback signal consists of an integer number of bits greater than or equal to log₂N. In addition to transmitting a feedback signal to be used as an index by the source for determining a desired transmit power, the feedback signal can encode, preferably in a binary format, a transmit power value corresponding to the desired source transmit power.

The presently preferred power control algorithm is well suited for use in uplink communication systems transmitting at a constant rate, such as for voice applications. For a given feedback rate, the network power control algorithm can reduce power consumption and save battery life for a given outage probability, as compared to a single link system employing optimal power control.

While described above in the context of a simplest possible network: one transmitter-receiver pair being assisted by one relay, the use of this invention is not limited to only this particular network topology. Known sub-optimal methods can be employed to advantage in order to obtain the performance gains from feedback as discussed above. It was also shown that it is preferred that network protocols managing contention in cooperative networks should collect some form of channel states from all participating links.

1. A method for reducing outages in a cooperative network comprising:
measuring a channel gain for each of a plurality of received signals, one of said received signals comprising a source signal;
executing an algorithm utilizing said channel gain of said source signal and at least one other of said plurality of channel gains to determine a source transmit power value; and
transmitting said source transmit power value to said source.

2. The method of claim 1 wherein said source transmit power value is expressed as a binary code.

3. The method of claim 2 wherein said binary code has a length greater than or equal to log₂N where N is equal to a number of said plurality of received signals.

4. The method of claim 2 wherein said binary code has a length of one bit.

5. The method of claim 2 wherein said binary code is an index.

6. The method of claim 1 wherein said source transmit power value is transmitted via a feedback channel.

7. The method of claim 1 further comprising:
receiving said transmitted source transmit power value; and
deducing a source transmit power from said source transmit power value.

8. The method of claim 7 wherein deducing comprises utilizing said transmit power value as an index to a table.

9. The method of claim 1 wherein executing said algorithm comprises:
utilizing said channel gain of said source signal and at least one other one of said plurality of channel gains to define a plurality of regions;
choosing a region corresponding to the plurality of utilized channel gains; and
deriving a source power value corresponding to said chosen region.

10. The method of claim 9 wherein deriving said source power value comprises:
deriving a first power level corresponding to a first one of said plurality of regions;
deriving a subsequent power level in recursive fashion from said first power level; and
setting said source transmit power value equal to said subsequent power level.

11. The method of claim 1 comprising the additional step of transmitting said source transmit power value to said relay.

12. The method of claim 7 comprising the additional step of transmitting a plurality of signals from said source signal at said source transmit power.

13. The method of claim 12 wherein said source transmit power is sufficient to ensure that said source signal arrives at a destination.

14. A cooperative network comprising:
A source for transmitting a source signal having a source transmit power said source capable of adjusting said source transmit power in response to a source transmit power value;
At least one relay for transmitting a relay signal; and
A destination for receiving said source signal and said at least one relay signal, executing a power control algorithm using a plurality of channel gains derived from said source signal and said at least one relay signal to produce said source transmit power value.

15. The network of claim 14 wherein said source transmit power value is a binary code.

16. The network of claim 15 wherein said binary code is an index.

17. The network of claim 14 additionally comprising a feedback channel on which is transmitted said source transmit power value.

18. The network of claim 15 wherein said binary code has a length greater than or equal to Log₂N where N is equal to said number of transmitted relay signals plus one.

19. A cooperative network comprising:
Means for measuring a channel gain for each of a plurality of received signals one of said received signals comprising a source signal;
Means for executing an algorithm utilizing said channel gain of said source signal and at least one other of said plurality of channel gains to determine a source transmit power value; and
Means for transmitting said source transmit power value to said source.

20. The network of claim 19 additionally comprising a feedback channel for transmitting said source transmit power value.

21. A system to minimize outages in a cooperative network comprising:
at least one source for transmitting a source signal;
at least one relay for transmitting a relay signal; and
at least one destination for receiving said source signal and said at least one relay signal wherein said destination executes a power control algorithm that considers a plurality of channel states corresponding to said source signal and said at least one relay signal to produce at least one bit of feedback that is sent back to the source from the destination.

22. A transceiver comprising:
Means for receiving a source signal and at least one relay signal; and
Means for executing a power control algorithm that considers a plurality of channel states corresponding to said source signal and said at least one relay signal to produce at least one bit of feedback.

23. The transceiver of claim 22 wherein said feedback comprises a source transmit power value.
